(19) United States
(12) Patent Application Publication
(10) Pub. No.: US 2026/0093797 A1
(43) Pub. Date: Apr. 2, 2026

(54) AUTO-CUSTOMIZING CONFIGURATION ASSESSMENT RULE VALUES FROM CAPTURED STATE OF A TEMPLATE MACHINE

(71) Applicant: CrowdStrike, Inc., Sunnyvale, CA (US)

(72) Inventors: Sushant Ravale, Pune (IN); Michael Glyer, Arlington, VA (US); David Bruce, Benton, TN (US)

(21) Appl. No.: 18/899,421

(22) Filed: Sep. 27, 2024

(51) Int. Cl. G06F 21/44

(52) U.S. Cl. CPC G06F 21/44

(57) ABSTRACT

The present disclosure provides an approach that obtains, from a template machine executing on a computing environment, a template machine configuration setting comprising a security rule with a template machine rule value. The present disclosure customizes, by a processing device, a benchmark security configuration based on the template machine rule value to produce a customized security configuration. The present disclosure then utilizes the customized security configuration to perform a configuration assessment of a computing machine executing in the computing environment to test a compliance of the computing machine.

### TECHNICAL FIELD

Aspects of the present disclosure relate to configuration assessment systems, and more particularly, to auto-customizing configuration assessment rule values based on a captured state of a template machine.

### BACKGROUND

Configuration assessment is an important process in information technology (IT) management that involves evaluating the settings, software, and hardware configurations of machines within an organization's environment, thereby enhancing the operational efficiency and security posture of the organization's environment through automated analysis and reporting mechanisms. The configuration assessment typically includes using a baseline or benchmark, such as Center for Internet Security (CIS) benchmarks, to provide detailed guidelines for secure and optimal configurations. By comparing a current state of the organization's systems against these benchmarks, organizations can identify discrepancies, vulnerabilities, and areas for improvement. This process is essential for maintaining the integrity, performance, and security of the IT infrastructure, as well as ensuring compliance with regulatory mandates and internal policies.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for producing a customized security configuration and using the customized security configuration to perform a configuration assessment of a customer machine, in accordance with some embodiments of the present disclosure.

FIG. 2A is a diagram that illustrates an example benchmark security configuration, in accordance with some embodiments of the present disclosure.

FIG. 2B is a diagram that illustrates an example template machine security configuration, in accordance with some embodiments of the present disclosure.

FIG. 2C is a diagram that illustrates an example customized security configuration, in accordance with some embodiments of the present disclosure.

FIG. 3 is a flow diagram of a method 400 for producing a customized security configuration and using the customized security configuration to perform a configuration assessment, in accordance with some embodiments.

FIG. 4 is a flow diagram of a method 400 for producing a customized security configuration and using the customized security configuration to perform a configuration assessment, in accordance with some embodiments.

FIG. 5 is a block diagram that illustrates an example system for producing a customized security configuration and using the customized security configuration to perform a configuration assessment, in accordance with some embodiments of the present disclosure.

FIG. 6 is a block diagram of an example computing device that may perform one or more of the operations described herein, in accordance with some embodiments of the present disclosure.

### DETAILED DESCRIPTION

As discussed above, an organization uses benchmarks with configuration assessment to ensure that machines within an organization's environment align with predefined standards, security policies, compliance requirements, and industry best practices. CIS benchmarks are a set of comprehensive, consensus-based guidelines designed to help organizations secure their IT systems. These benchmarks encompass hundreds of rules, each specifying configurations and best practices aimed at mitigating security risks and ensuring compliance. Each security rule typically includes a rule value parameter (e.g., “value must be less than 24”) and an associated rule value (e.g., “22”). For example, a rule might dictate a particular password complexity requirement or a specific setting for network security. These benchmark rule values serve as a standard against which the organization's systems are compared to identify compliance gaps and vulnerabilities.

In the configuration assessment process, administrators may manually update the benchmark rule values to reflect the organization's unique security policies and operational needs. This task is often labor-intensive and requires a deep understanding of both the CIS benchmarks and the specific requirements of the organization. Administrators review and adjust each rule to ensure it aligns with the organization's security posture, regulatory obligations, and operational constraints. This manual updating process can be time-consuming and prone to errors, particularly in large organizations with complex IT environments.

Compounding this challenge is the fact that organizations typically support a wide array of operating systems and operating system versions, each with its own unique CIS benchmark. This added complexity means that administrators are required to manage multiple sets of benchmark rules, each tailored to the particular configurations and security considerations of different operating systems. For example, the CIS benchmark for Windows® 10 differs significantly from that for a Linux® distribution or an older version of Windows®. Ensuring that all systems comply with their respective benchmarks requires meticulous attention to detail and a robust process for tracking and implementing updates across the entire IT infrastructure.

The present disclosure addresses the above-noted and other deficiencies by using a processing device to obtain template machine configuration settings from a template machine executing on a customer environment (also referred to herein as computing environment). The template machine configuration settings include a security rule with a template machine rule value. The processing device customizes a benchmark security configuration based on the template machine rule value to produce a customized security configuration. In turn, the processing device performs a configuration assessment of a customer machine (also referred to herein as computing machine) executing in the customer environment utilizing the customized security configuration to test the compliance of the customer machine.

In some embodiments, the benchmark security configuration includes the security rule with a benchmark rule value. The processing device determines that the template machine rule value is not equal to the benchmark rule value, and updates the benchmark rule value with the template machine rule value accordingly. In some embodiments, the processing device then adds a visual indicator to the security rule and displays the customized security configuration with the security rule and the visual indicator on a display that indicates the rule value is updated.

In some embodiments, the processing device obtains customer machine configuration settings corresponding to a customer machine that includes the security rule with a customer machine rule value. The processing device determines whether the customer machine rule value violates the security rule based on the template machine rule value. In some embodiments, when the customer machine rule value violates the security rule based on the template machine rule value, the processing device sends a notification indicating that the customer machine is in non-compliance of the customized security configuration.

In some embodiments, the benchmark security configuration includes the security rule with a benchmark rule value. The processing device determines whether the security rule includes an ambiguous rule value parameter. An ambiguous rule value parameter is a rule value parameter that does not include a single set of allowable contiguous values. For example, a rule value parameter of “must be less than 24” is unambiguous because it includes a single set of allowable contiguous values (0 to 23). However, a rule value parameter of “must not be six” is ambiguous because it includes two sets of allowable contiguous values (less than 6 and greater than 6). When the security rule includes an ambiguous rule value parameter, the processing device inhibits the benchmark rule value from being updated and, in some embodiments, adds a corresponding visual indicator to the security rule. The processing device then displays the customized security configuration with security rule and the visual indicator indicating that the rule value has not been updated.

As discussed herein, the present disclosure provides an approach that improves the operation of a computer system by auto-populating security rule values using template machine rule values. This approach enhances system efficiency and accuracy by automating the otherwise manual and error-prone process of configuring security settings. By leveraging predefined template rule values, the system quickly and accurately configures security settings across various platforms and environments, ensuring consistent application of security policies. This automation reduces the administrative burden on IT staff, allowing them to focus on more strategic tasks rather than the minutiae of manual configuration.

Furthermore, auto-populating security rule values minimizes the risk of misconfigurations, which are often the result of human error. Misconfigurations can lead to security vulnerabilities, system instability, and compliance issues. By standardizing the configuration process, the approach ensures that all systems adhere to best practices and regulatory requirements, thereby enhancing overall system security and reliability. Additionally, the approach facilitates quicker deployment and scaling of secure systems, as the automated process can be easily replicated across multiple machines and environments, thereby improving the agility and responsiveness of the IT infrastructure.

In addition, the present disclosure provides an improvement to the technological field of cybersecurity by streamlining the configuration process and reducing the potential for human error through automated rule value population. This not only ensures a higher level of security compliance but also accelerates the implementation of security measures across diverse and complex IT environments. The use of template machine rule values as a basis for configuration also allows for rapid updates and adjustments in response to emerging threats, making the security posture of the organization more adaptive and resilient. Overall, this approach represents a significant advancement in the management and enforcement of security configurations, contributing to a more secure and efficient technological ecosystem.

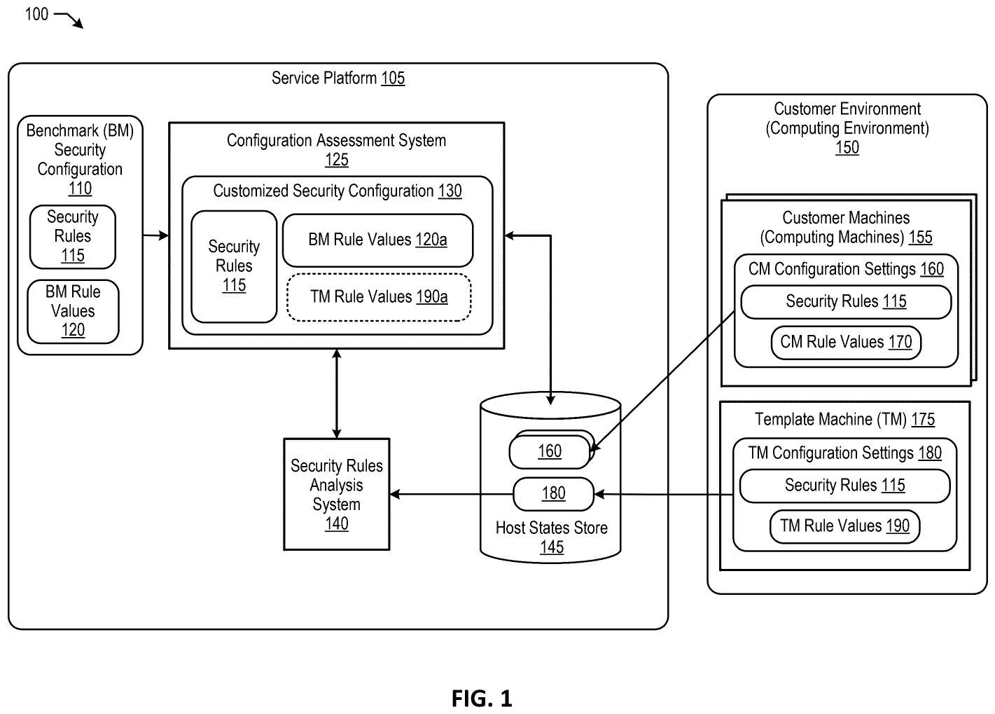

FIG. 1 is a block diagram that illustrates an example system for producing a customized security configuration and using the customized security configuration to perform a configuration assessment of a customer machine, in accordance with some embodiments of the present disclosure.

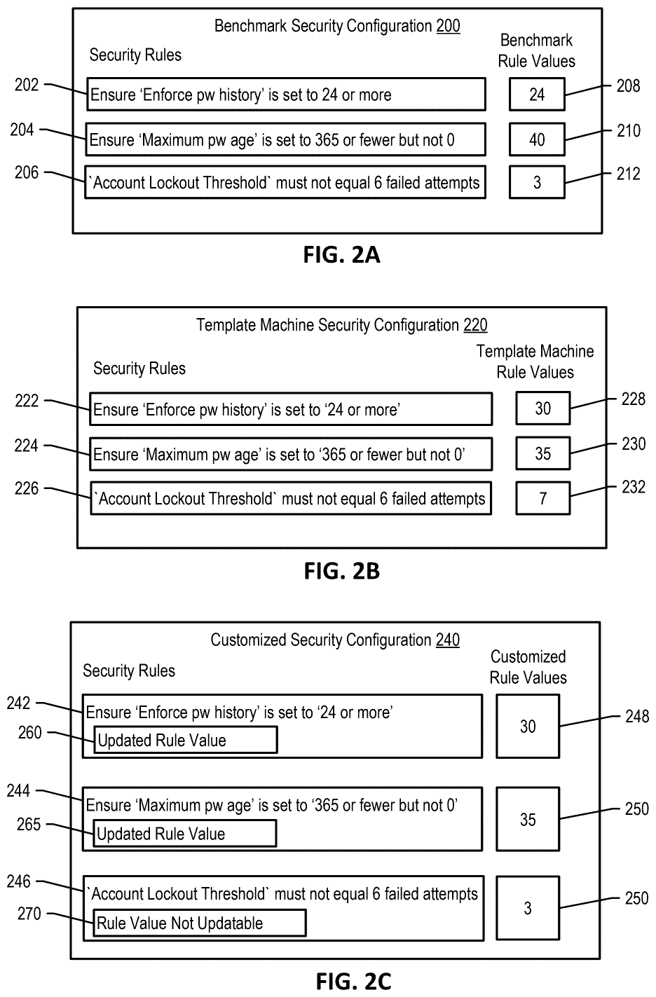

System 100 includes service platform 105 and customer environment 150. Service platform 105 includes configuration assessment system 125 designed to evaluate and ensure the compliance, security, and optimal performance of customer environment 150. Configuration assessment system 125 monitors and assesses the configurations of various customer machines 155, applications, and operating systems based on predefined standards and best practices, such as CIS benchmarks (benchmark security configuration 110). In one embodiment, service platform 105 obtains CIS Benchmarks from the Center for Internet Security's official repository, ensuring that it uses the most up-to-date and consensus-based security configuration guidelines. Benchmark security configuration 110 includes security rules 115 and corresponding benchmark rule values 120. For example, a security rule may require that the password history may not have the same password for at least 24 password changes, and the corresponding benchmark rule value would be 23 passwords (see FIG. 2A and corresponding text for further details).

Service platform 105 frequently captures configuration settings from machines running on customer environment 150. Customer environment 150 includes custom machines 155 and template machine 175. Template machine 175 serves as a standardized, pre-configured model used to streamline the deployment and configuration of other machines (e.g., customer machines 155) used by the customer that inherits and may further customize settings from the template machine 175. Template machine configuration settings 180 includes security rules 115 and template machine rule values 190, which are predicated on customer environment 150 and may be different from benchmark rule values 120. Service platform 105 stores customer machine configuration settings 160 and template machine configuration settings 180 in host states store 145.

Configuration assessment system 125 analyzes security rules 115 to determine whether any of security rules 115 include an ambiguous rule value parameter. For example, an ambiguous rule value parameter would be “the value cannot equal 6.” In this example, the rule value parameter corresponds to more than one set of allowable contiguous values and is therefore ambiguous as discussed above. Configuration assessment system 125 marks those security rules 115 that include ambiguous rule value parameters accordingly and inhibits their rule values from being updated. Configuration assessment system 125 may also add a visual indicator to these rules and displays them such that an administrator can change them as needed (see FIG. 2C and corresponding text for further details).

Configuration assessment system 125 then compares, for each non-ambiguous security rule 115, the corresponding benchmark rule value 120 with the template machine rule value 190. When a discrepancy exists, configuration assessment system 125 updates the rule value of the security rule to the template machine rule value (see FIGS. 2A-2C and corresponding text for further details). When configuration assessment system 125 finishes, configuration assessment system 125 produces customized security configuration 130 that includes security rules 115, benchmark rule values 120a, and template machine rule values 190a. Benchmark rule values 120a correspond to the security rules 115 whose rule values are unchanged (e.g., remains as benchmark rule values 120). Template machine rule values 190a correspond to the security rules 115 whose rule values are updated (e.g., updated to the corresponding template machine rule value 190).

Once configuration assessment system 125 creates customized security configuration 130, configuration assessment system 125 performs a configuration assessment on customer machines 155. In one embodiment, configuration assessment system 125 analyzes customer machine configuration settings 160 from host state store 145 and generates notifications that indicate whether any of customer machines 155 are non-compliant.

FIG. 2A is a diagram that illustrates an example benchmark security configuration, in accordance with some embodiments of the present disclosure.

Benchmark security configuration 200 includes security rules 202, 204, and 206. Benchmark security configuration 200 also includes corresponding benchmark rule values 208, 210, and 212. Security rule 202 includes an unambiguous rule value parameter (24 or more) and corresponds to a single set of allowable contiguous values. Security rule 204 also includes an unambiguous rule value parameter (365 or fewer but not 0) and corresponds to a single set of allowable contiguous values. As such, configuration assessment system 125 may update benchmark rule values 208, 210, or a combination thereof based on template machine rule values 228, 230, or a combination thereof shown in FIG. 2B and discussed below.

However, security rule 206 includes an ambiguous rule parameter (must not equal 6 failed attempts) and corresponds to two sets of allowable contiguous values (less than 6 and greater than 6). As such, configuration assessment system 125 inhibits benchmark rule value 212 from being updated (see FIG. 2C and corresponding text for further details).

FIG. 2B is a diagram that illustrates an example template machine security configuration, in accordance with some embodiments of the present disclosure.

Template machine security configuration 220 includes security rules 222, 224, and 226 which correspond to security rules 202, 204, and 206 shown in FIG. 2A. Template machine security configuration 220 includes corresponding template machine rule values 228, 230, and 232. Configuration assessment system 125 evaluates template machine security configuration 220 and updates rule values accordingly as discussed herein to produce customized security configuration 240 shown in FIG. 2C.

FIG. 2C is a diagram that illustrates an example customized security configuration, in accordance with some embodiments of the present disclosure.

Customized security configuration 240 includes security rule 242, 244, and 246 which correspond to security rules 202, 204, and 206 shown in FIG. 2A. Custom rule value 248 has been updated based on template machine rule value 228, and security rule 242 includes visual indicator 260 that indicates the rule value is updated. Custom rule value 250 has been updated based on template machine rule value 230, and security rule 244 includes visual indicator 265 that indicates the rule value is updated. However, custom rule value 250 has not been updated and remains the same as benchmark rule value 212 because security rule 246 includes an ambiguous rule value parameter as discussed above. As such, security rule 246 includes visual indicator 270 that indicates the rule value is not updatable.

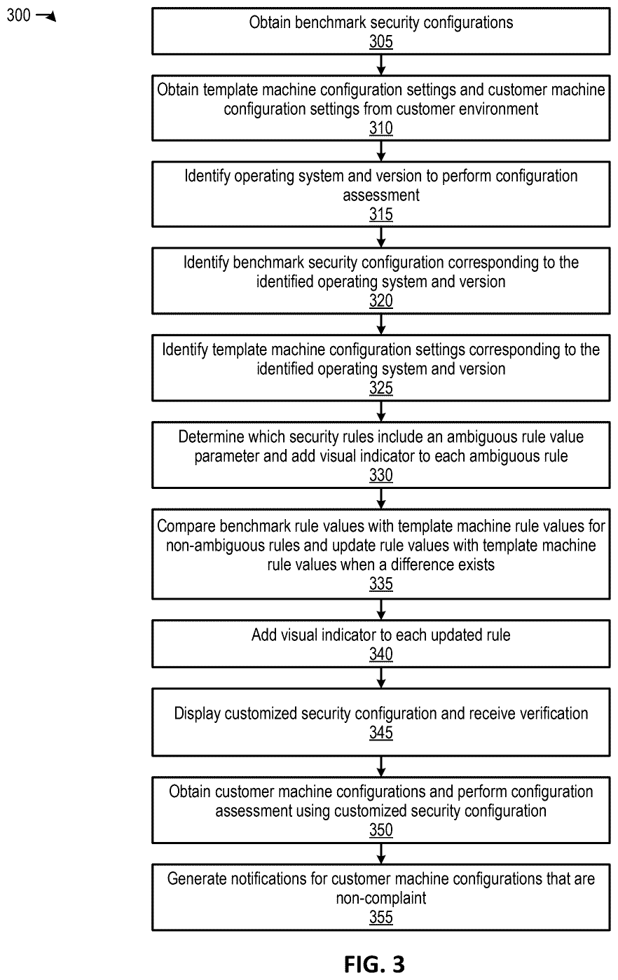

FIG. 3 is a flow diagram of a method 400 for producing a customized security configuration and using the customized security configuration to perform a configuration assessment, in accordance with some embodiments.

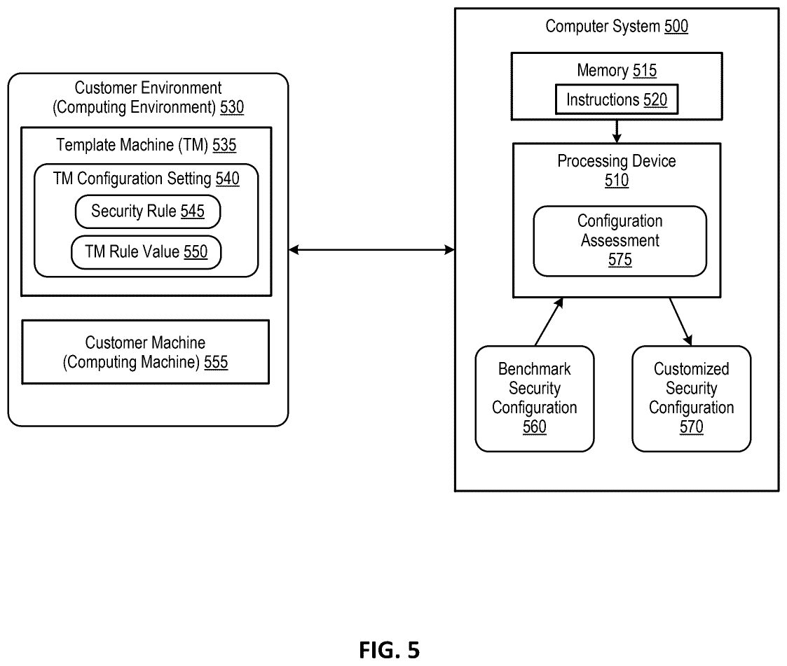

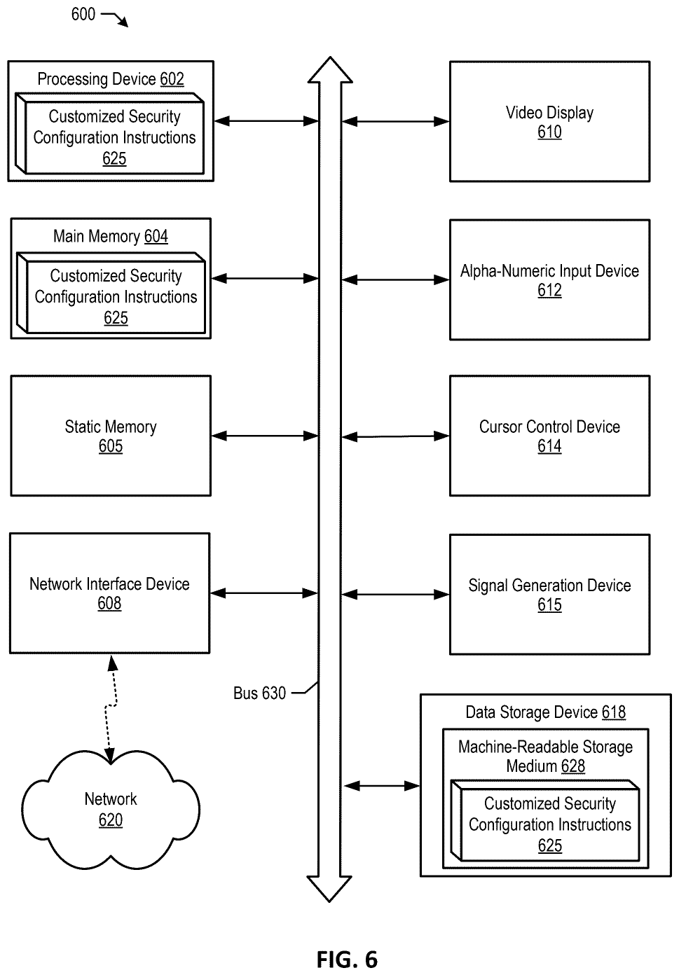

Method 300 may be performed by processing logic that may include hardware (e.g., a processing device), software (e.g., instructions running/executing on a processing device), firmware (e.g., microcode), or a combination thereof. In some embodiments, at least a portion of method 400 may be performed by configuration assessment system 125 (shown in FIG. 1), processing device 510 (shown in FIG. 5), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 400 may be performed in an order different than presented, and that not all of the blocks in method 400 may be performed.

With reference to FIG. 3, method 300 begins at block 305, whereupon processing logic obtains benchmark security configurations 110, such as CIS benchmark security configurations as discussed herein. In one embodiment, processing logic obtains multiple benchmark security configurations 110 that correspond to multiple operating systems and multiple versions. At block 310, processing logic obtains template machine configuration settings 180 and customer machine configuration settings 160 from customer environment 150.

At block 315, processing logic identifies an operating system and version to perform configuration assessment (e.g., provided by an administrator). At block 320, processing logic identifies one of the benchmark security configurations 110 corresponding to the identified operating system and version. At block 325, processing logic identifies the template machine configuration settings 180 that correspond to the identified operating system and version. In one embodiment, template machine configuration settings 180 are labeled according to operating system and version, which processing logic utilizes to identify the correct template machine configuration settings 180.

At block 330, processing logic determines which of the security rules from the benchmark security configuration 110 include an ambiguous value parameter and adds a visual indicator accordingly as discussed herein. In one embodiment, processing logic performs a first pass of the security rules to identify the ambiguous rules. In another embodiment, processing logic processes each rule individually to determine if the rule is ambiguous. In this embodiment, if the rule is not ambiguous, processing logic proceeds to evaluate the rule values (blocks 335, 340).

At block 335, processing logic compares the benchmark rule values to the template rule values for the non-ambiguous rules and updates the rule values with template machine rule values when a difference in value is determined. At block 340, processing logic adds a visual indicator to each updated rule and, at block 345, processing logic displays the customized security configuration 130. Processing logic then receives a verification (e.g., from an administrator) that customized security configuration 130 is correct (or receives updates from the administrator).

At block 350, processing logic obtains customer machine configuration settings 160 and performs configuration assessment using customized security configuration 130 to test the compliance of customer machines 155. At block 355, processing logic generates notifications for those corresponding customer machines 155 that are non-compliant. For example, one of customer machine configuration settings 160 may include a password history setting that does not meet the customized rule value in customized security configuration 130.

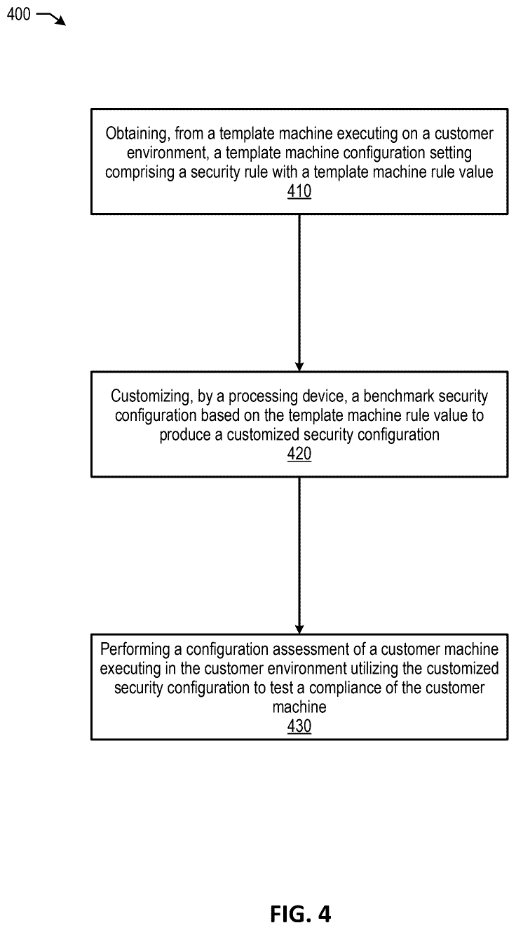

FIG. 4 is a flow diagram of a method 400 for producing a customized security configuration and using the customized security configuration to perform a configuration assessment, in accordance with some embodiments.

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by configuration assessment system 125 (shown in FIG. 1), processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic obtains, from a template machine executing on a customer environment, a template machine configuration setting 180 comprising a security rule 115 with a template machine rule value 190. In one embodiment, processing logic obtains the template machine configuration setting 180 from host states store 145 shown in FIG. 1.

At block 420, processing logic customizes a benchmark security configuration 110 based on the template machine rule value 190 to produce a customized security configuration 130. In one embodiment, the benchmark security configuration 110 comprises the security rule 115 with a benchmark rule value 120. In this embodiment, processing logic determines that the template machine rule value 190 is not equal to the benchmark rule value 120, and updates the benchmark rule value 120 with the template machine rule value 190 accordingly. In some embodiments, the processing logic adds a visual indicator to the security rule 115 and displays the customized security configuration 130 with the security rule and the visual indicator on a display (see FIG. 2C and corresponding text for further details).

At block 430, processing logic performs a configuration assessment of a customer machine 155 executing in customer environment 150 utilizing customized security configuration 130 to test a compliance of customer machine 155. In some embodiments, processing logic obtains customer machine configuration settings 160 from host states store 145 shown in FIG. 1, which includes the security rule 115 with a customer machine rule value 170. Processing logic determines whether the customer machine rule value 170 violates the security rule 115 with the template machine rule value 190. In some embodiments, processing logic then sends a notification indicating that the customer machine 155 is in non-compliance of the customized security configuration 130.

FIG. 5 is a block diagram that illustrates an example system for producing a customized security configuration and using the customized security configuration to perform a configuration assessment, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to obtain, from template machine 535 executing on customer environment 530, template machine configuration setting 540 that includes security rule 545 and template machine rule value 550. Instructions 520, when executed by processing device 510, further cause processing device 510 to customize benchmark security configuration 560 based on template machine rule value 550 to produce customized security configuration 570. Instructions 520, when executed by processing device 510, further cause processing device 510 to perform configuration assessment 575 of customer machine 555 executing in customer environment 530 utilizing the customized security configuration 570 to test a compliance of customer machine 555.

FIG. 6 illustrates a diagrammatic representation of a machine in the example form of a computer system 600 within which a set of instructions, for causing the machine to perform any one or more of the methodologies discussed herein for producing a customized security configuration and using the customized security configuration to perform a configuration assessment.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute customized security configuration instructions 625, for performing the operations and steps discussed herein.

The data storage device 618 may include a machine-readable storage medium 628, on which is stored one or more sets of customized security configuration instructions 625 (e.g., software) embodying any one or more of the methodologies of functions described herein. The customized security configuration instructions 625 may also reside, completely or at least partially, within the main memory 604 or within the processing device 602 during execution thereof by the computer system 600; the main memory 604 and the processing device 602 also constituting machine-readable storage media. The customized security configuration instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “customizing,” “utilizing,” “determining,” “updating,” “adding,” “displaying,” “sending,” “inhibiting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
obtaining, from a template machine executing on a computing environment, a template machine configuration setting comprising a security rule with a template machine rule value;
customizing, by a processing device, a benchmark security configuration based on the template machine rule value to produce a customized security configuration; and
utilizing the customized security configuration, performing a configuration assessment of a computing machine executing in the computing environment to test a compliance of the computing machine.

2. The method of claim 1, wherein the benchmark security configuration comprises the security rule with a benchmark rule value, the customizing further comprising:
determining that the template machine rule value is not equal to the benchmark rule value; and
updating the security rule with the template machine rule value in response to determining that the template machine rule value is not equal to the benchmark rule value.

3. The method of claim 2, further comprising:
adding a visual indicator to the security rule in response to the updating; and
displaying the customized security configuration with the security rule and the visual indicator on a display.

4. The method of claim 2, further comprising:
obtaining computing machine configuration settings corresponding to the computing machine, wherein the computing machine configuration settings comprise the security rule with a computing machine rule value; and
determining whether the computing machine rule value violates the security rule based on the template machine rule value.

5. The method of claim 4, further comprising:
in response to determining that the computing machine rule value violates the security rule based on the template machine rule value, sending a notification indicating that the computing machine is in non-compliance of the customized security configuration.

6. The method of claim 1, wherein the benchmark security configuration comprises the security rule with a benchmark rule value, the method further comprising:
determining whether the security rule comprises an ambiguous rule value parameter that corresponds to more than one set of allowable contiguous values; and
inhibiting the benchmark rule value from being updated in response to determining that the security rule comprises the ambiguous rule value parameter.

7. The method of claim 6, further comprising:
adding a visual indicator to the security rule in response to determining that the security rule comprises the ambiguous rule value parameter; and
displaying the customized security configuration with the security rule and the visual indicator on a display.

8. A system comprising:
a memory; and
a processing device, that is operatively coupled to the memory, to:
obtain, from a template machine executing on a computing environment, a template machine configuration setting comprising a security rule with a template machine rule value;
customize a benchmark security configuration based on the template machine rule value to produce a customized security configuration; and
utilize the customized security configuration to perform a configuration assessment of a computing machine executing in the computing environment to test a compliance of the computing machine.

9. The system of claim 8, wherein the benchmark security configuration comprises the security rule with a benchmark rule value, and wherein the processing device is further to:
determine that the template machine rule value is not equal to the benchmark rule value; and
update the security rule with the template machine rule value in response to determining that the template machine rule value is not equal to the benchmark rule value.

10. The system of claim 9, wherein the processing device is further to:
add a visual indicator to the security rule in response to the updating; and
display the customized security configuration with the security rule and the visual indicator on a display.

11. The system of claim 9, wherein the processing device is further to:
obtain computing machine configuration settings corresponding to the computing machine, wherein the computing machine configuration settings comprise the security rule with a computing machine rule value; and
determine whether the computing machine rule value violates the security rule based on the template machine rule value.

12. The system of claim 11, wherein the processing device is further to:
send a notification indicating that the computing machine is in non-compliance of the customized security configuration in response to determining that the computing machine rule value violates the security rule based on the template machine rule value.

13. The system of claim 8, wherein the benchmark security configuration comprises the security rule with a benchmark rule value, and wherein the processing device is further to:
determine whether the security rule comprises an ambiguous rule value parameter that corresponds to more than one set of allowable contiguous values; and
inhibit the benchmark rule value from being updated in response to determining that the security rule comprises the ambiguous rule value parameter.

14. The system of claim 13, wherein the processing device is further to:
add a visual indicator to the security rule in response to determining that the security rule comprises the ambiguous rule value parameter; and
display the customized security configuration with the security rule and the visual indicator on a display.

15. A non-transitory computer readable medium, storing instructions that, when executed by a processing device, cause the processing device to:
obtain, from a template machine executing on a computing environment, a template machine configuration setting comprising a security rule with a template machine rule value;
customize, by the processing device, a benchmark security configuration based on the template machine rule value to produce a customized security configuration; and
utilize the customized security configuration to perform a configuration assessment of a computing machine executing in the computing environment to test a compliance of the computing machine.

16. The non-transitory computer readable medium of claim 15, wherein the benchmark security configuration comprises the security rule with a benchmark rule value, and wherein the processing device is further to:
determine that the template machine rule value is not equal to the benchmark rule value; and
update the security rule with the template machine rule value in response to determining that the template machine rule value is not equal to the benchmark rule value.

17. The non-transitory computer readable medium of claim 16, wherein the processing device is further to:
add a visual indicator to the security rule in response to the updating; and
display the customized security configuration with the security rule and the visual indicator on a display.

18. The non-transitory computer readable medium of claim 16, wherein the processing device is further to:
obtain computing machine configuration settings corresponding to the computing machine, wherein the computing machine configuration settings comprise the security rule with a computing machine rule value; and
determine whether the computing machine rule value violates the security rule based on the template machine rule value.

19. The non-transitory computer readable medium of claim 18, wherein the processing device is further to:
send a notification indicating that the computing machine is in non-compliance of the customized security configuration in response to determining that the computing machine rule value violates the security rule based on the template machine rule value.

20. The non-transitory computer readable medium of claim 15, wherein the benchmark security configuration comprises the security rule with a benchmark rule value, and wherein the processing device is further to:
determine whether the security rule comprises an ambiguous rule value parameter that corresponds to more than one set of allowable contiguous values; and
inhibit the benchmark rule value from being updated in response to determining that the security rule comprises the ambiguous rule value parameter.
